(19) United States
(12) Patent Application Publication
(10) Pub. No.: US 2026/0056648 A1
(43) Pub. Date: Feb. 26, 2026

(54) Interactive Deliverable Asset Placement in a Map Module

(71) Applicant: William James Eaton, JR., Hudson, NH (US)

(72) Inventor: William James Eaton, JR., Hudson, NH (US)

(21) Appl. No.: 19/316,945

(22) Filed: Sep. 2, 2025

Related U.S. Application Data
(63) Continuation-in-part of application No. 18/623,805, filed on Apr. 1, 2024.

(51) Int. Cl. G06F 3/0484; G06Q 10/083

(52) U.S. Cl. CPC G06F 3/0484; G06Q 10/083

(57) ABSTRACT

A system and method are disclosed for interactive placement of deliverable assets in a map module. A dispatcher interface generates a customer-accessible map, enabling the customer to reposition and orient a deliverable asset marker. Placement data is stored in a database, with automatic notifications sent to the dispatcher, and a driver interface displaying the finalized placement for delivery. The system may include a synchronized truck-visualization marker to represent clearance requirements, rotation controls for orientation adjustments, a 180-degree flip to specify door direction, and heading adjustments to align markers with map view changes. Both asset and truck markers scale relative to map zoom, ensuring accurate visualization. These features improve communication among dispatcher, customer, and driver, reduce errors, and enhance efficiency in the delivery of containers, dumpsters, portable restrooms, mobile offices, and other temporary on-site assets.

### CROSS-REFERENCE TO RELATED APPLICATIONS

This application is a Continuation-in-Part (CIP) of U.S. patent application Ser. No. 18/623,805, filed on Apr. 1, 2024, entitled “Interactive Container Placement in a Map Module,” which is incorporated herein by reference in its entirety.

### FIELD OF INVENTION

The disclosure relates to an interactive delivery management system for temporary on-site deliverable asset placement. More particularly, it concerns systems and methods for facilitating the delivery and placement of a wide variety of temporary on-site units, including but not limited to storage containers for residential, commercial, and construction use, waste management dumpsters and refuse containers, portable restrooms, mobile offices, and other modular or transportable structures requiring accurate on-site positioning.

### BACKGROUND

Renting deliverable assets such as storage containers, dumpsters, portable restrooms, mobile offices, and other temporary modular or transportable structures is a common practice among homeowners, businesses, and government agencies seeking short-term storage, sanitation, and workspace solutions. These assets are typically modeled after shipping containers (also known as Conex boxes) and are transported by truck or trailer. They generally weigh between 2,000 and 10,000 pounds depending on type. Lengths range from 8 to 45 feet, with variations selected to meet customer and site requirements. Many deliverable assets are directional, meaning their orientation or door configuration directly impacts usability and delivery placement.

Delivering such assets presents significant logistical challenges. Placement requires substantial clearance for the delivery vehicle, often between 70 and 120 feet depending on asset size and truck type. To complete delivery, the truck must be able to back into the designated location, set the asset in place, and then pull forward to exit from underneath it. Customers frequently underestimate this requirement, which can result in inaccessible sites or unexpected complications during delivery. Orientation further complicates the process, as customers must specify whether doors should face toward the cab or the rear of the truck. Failure to clearly communicate these details can lead to inefficient use, repositioning delays, or additional delivery costs.

Traditional planning methods rely on verbal descriptions, sketches, or static maps, which often fail to capture the spatial realities of a delivery site. Without an accurate means of visualizing truck clearance, door orientation, and placement options, dispatchers and customers struggle to communicate precise requirements. This lack of clarity increases the likelihood of miscommunication and costly adjustments during delivery.

Municipal and regulatory requirements add another layer of complexity to asset delivery and placement. Local governments often impose guidelines or permitting procedures that govern where and how temporary assets may be positioned. These rules vary widely across jurisdictions, and failure to comply can result in fines, delays, or forced relocation. A placement system that is both flexible and precise is therefore necessary to maintain compliance while supporting efficient operations.

Existing mapping tools provide only basic functions such as static pins or markers, which cannot accurately convey orientation, clearance, or door direction. They lack interactive controls and do not support coordination between dispatcher, customer, and driver. As a result, drivers may arrive on site without a clear understanding of the required location, approach, or orientation, which increases the risk of error.

These limitations lead to wasted time, customer frustration, and potential safety hazards during placement. They also increase operational costs for delivery companies, who may need to reschedule or reposition assets.

Accordingly, there is a need for a system that integrates interactive mapping, orientation controls, vehicle clearance visualization, and synchronized communication among all parties involved in the delivery process. Such a system should allow customers to clearly specify position and orientation, provide dispatchers with accurate placement data, and give drivers a precise view of the finalized instructions. By addressing these longstanding challenges, the disclosed invention improves efficiency, reduces miscommunication, and enhances customer satisfaction in the placement of temporary deliverable assets.

### SUMMARY

In one embodiment, a system for interactive placement of deliverable assets in a map module is provided. In some embodiments, the system comprises a dispatcher interface for generating a customer-accessible map module and transmitting access through a hyperlink or secure portal. The customer interface presents a deliverable asset marker that can be repositioned and reoriented, with placement data submitted to a central database. A notification system alerts the dispatcher when customer submission is complete, and a driver interface provides the designated driver with the finalized placement for accurate delivery.

The system may further include a truck-visualization marker that moves synchronously with the deliverable asset marker to illustrate delivery vehicle clearance. The map module provides controls to rotate the deliverable asset marker in increments, flip it 180 degrees to adjust door orientation, and adjust map heading while maintaining synchronized marker orientation. Both the deliverable asset marker and truck visualization marker dynamically scale in proportion to the zoom level of the map, ensuring accurate representation of size and clearance.

In another aspect, a method is provided for initializing a customer map module, allowing customer manipulation of a deliverable asset marker, updating a database upon submission, and transmitting placement data to a dispatcher and driver. A non-transitory computer-readable medium is also disclosed, storing instructions to perform these operations.

### BRIEF DESCRIPTION OF THE DRAWINGS

FIG. 1 is a block diagram of the system workflow.

FIG. 2 illustrates a dispatcher interface.

FIG. 3 illustrates dispatcher settings.

FIG. 4 illustrates the customer map module.

FIG. 5 illustrates the driver interface.

FIG. 6 illustrates the system method flow.

FIGS. 7A-7J illustrates customer interface features.

FIG. 7K illustrates prior art.

FIG. 8 illustrates asset customization.

FIG. 9 illustrates truck customization.

FIG. 10 illustrates marker rotation.

FIG. 11 illustrates marker dragging updates.

FIG. 12 illustrates synchronized dragging.

FIG. 13 illustrates multiple markers.

FIG. 14 illustrates scaling with zoom.

### DETAILED DESCRIPTION OF THE INVENTION

The following description, in conjunction with the accompanying drawings, provides exemplary embodiments of a system for interactive deliverable asset placement within a map module. The system streamlines the process of visualizing, selecting, and confirming placement locations, thereby improving delivery logistics. The examples provided herein are intended to be illustrative rather than exhaustive, and variations may be made without departing from the scope of the invention. For clarity, descriptions of well-known functions commonly used in logistics systems are omitted.

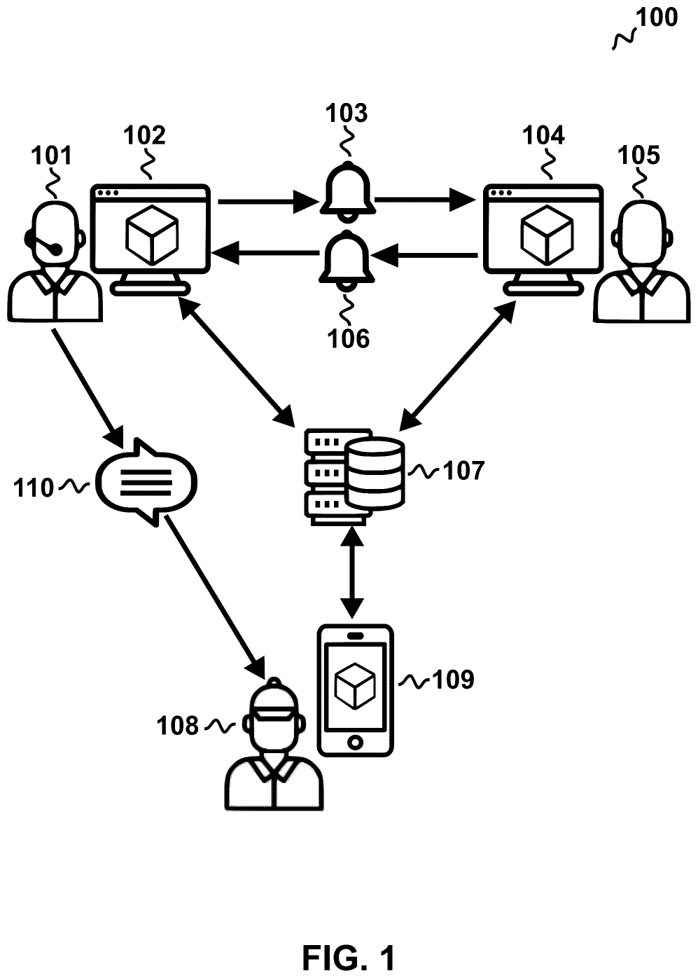

FIG. 1 illustrates a flow diagram of system (100) implementing an embodiment of the present invention. This system (100) allows customers (105) to visually select the desired location for their deliverable asset on a map, thereby enhancing their ability to specify precise placement preferences during the placement process.

To initiate the process, the dispatcher (101) utilizes the dispatcher interface (102) to input all necessary information for initializing a virtual map module. Once the dispatcher (101) enters the required details, a hyperlink is generated and transmitted to the customer (105) by way of a notification (103). Simultaneously, data is transmitted to the central server/database (107) for storage and processing.

Upon receiving the notification (103), the customer (105) opens the provided hyperlink directing them to interact with the system. The customer (105) can adjust deliverable asset markers' position and orientation on the virtual map. Placement adjustments made by the customer (105) are reflected in the user interface, and upon finalizing the placement, the customer (105) submits the request, triggering an update to the database (107) with the deliverable asset's coordinates, orientation, zoom, and heading.

As used herein, “orientation” refers to the angular positioning of the deliverable asset marker within the map module, including the direction of the doors, the angular rotation of the asset within the map view, or its alignment relative to the delivery vehicle.

Additionally, a notification (106) is sent to the dispatcher (101), signaling completion of the process by the customer (105). Subsequently, the dispatcher (101) communicates with the designated driver (108) to convey placement details. The driver (108), equipped with the driver interface (110), accesses their own map to view the deliverable asset placement exactly as specified by the customer (105). This seamless communication and visualization process among the dispatcher (101), the customer (105), and the driver (108) ensures efficient and accurate placement of deliverable assets.

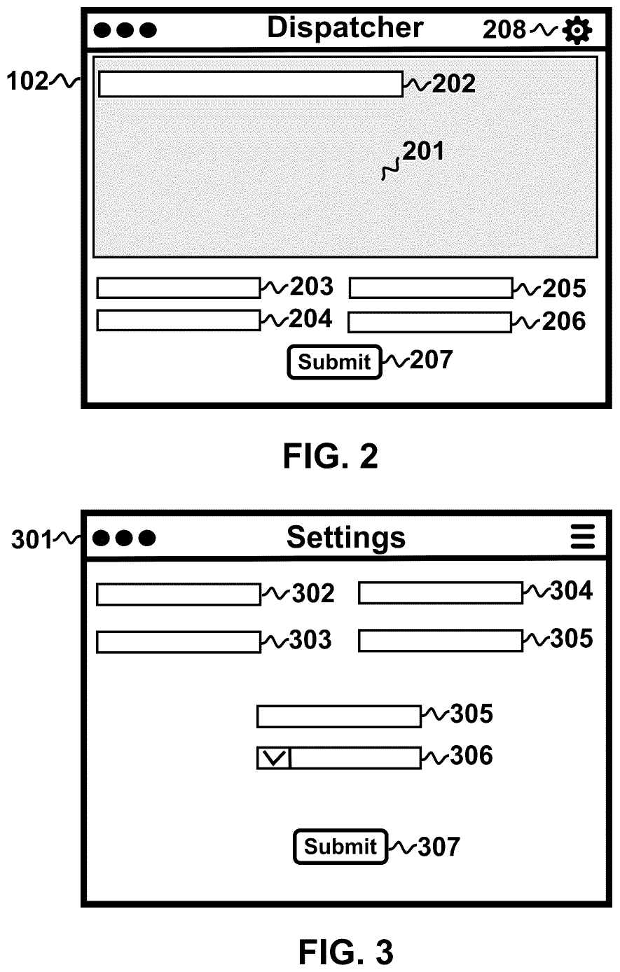

FIG. 2 illustrates the dispatcher interface (102) with a map configuration module (201). Input fields include an address field (202), which auto-completes and geocodes entries, an email field (203), a unique ID (204), and fields for asset size (205) and type (206). Once information is entered, a submit control (207) transmits the details to the database (107) and generates the customer-accessible map module.

The interface further includes a settings control (208), giving dispatchers flexibility to configure operational parameters and customize the appearance of the system.

FIG. 3 shows the dispatcher settings screen (301), which enables customization of asset and truck markers. Input fields (302) and (303) configure deliverable asset line and fill colors, while fields (304) and (305) configure truck marker line and fill colors. Field (306) sets the rotation variable, controlling the increments available for customer rotation (e.g., 10°). Field (307) specifies customer access permissions, determining whether access is granted via hyperlink or direct portal login.

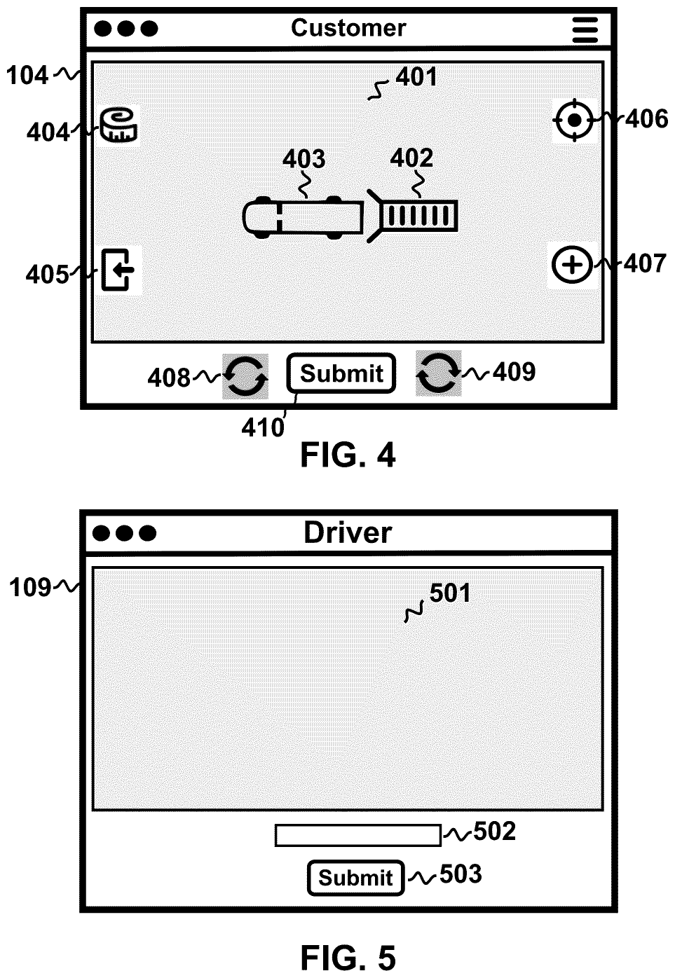

FIG. 4 illustrates the customer interface (104) with a map module (401). At its center is the deliverable asset marker (402) and the truck-visualization marker (403). The interface includes several controls to guide placement: a show/hide control (404) to toggle display of the truck marker, a flip control (405) to adjust door orientation by 180 degrees, a heading control (406) to rotate the map view, an add control (407) to insert additional assets, rotation controls (408, 409) for clockwise and counter-clockwise adjustment, and a submit control (410) to finalize placement.

These interactive features empower customers to visualize placement accurately, specify orientation requirements, and ensure sufficient delivery space.

FIG. 5 illustrates the driver interface (109) with a driver map module (501). The driver enters the placement ID (502) to retrieve the confirmed placement. The system displays the finalized location and orientation, ensuring that delivery matches customer intent.

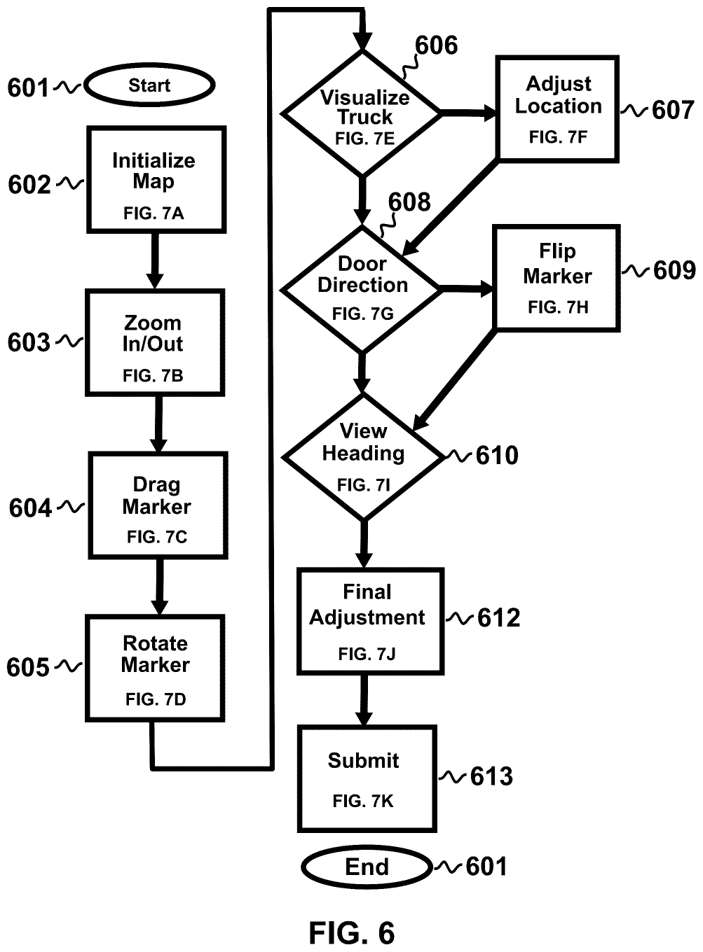

FIG. 6 provides an overview of the interactive placement method. The process begins with initialization of the map module (602), followed by zoom adjustments (603) to refine the view. The customer then drags the deliverable asset marker (604) to the desired location and may rotate it (605) for proper orientation. Truck visualization can be activated at step (606), after which the marker placement may be further refined (607). Door direction can be adjusted (608) or flipped (609), and the map heading may be changed (610) to view the site from alternate perspectives. Final adjustments (611) ensure accuracy, and submission (612) updates the database while triggering notification to the dispatcher (613).

Steps may be performed in any order. Global Positioning System (GPS) technology may be used to update the coordinates of the deliverable asset marker in real time as the customer manipulates it on the map. Orientation values are updated separately by the system software in the background to ensure accurate representation.

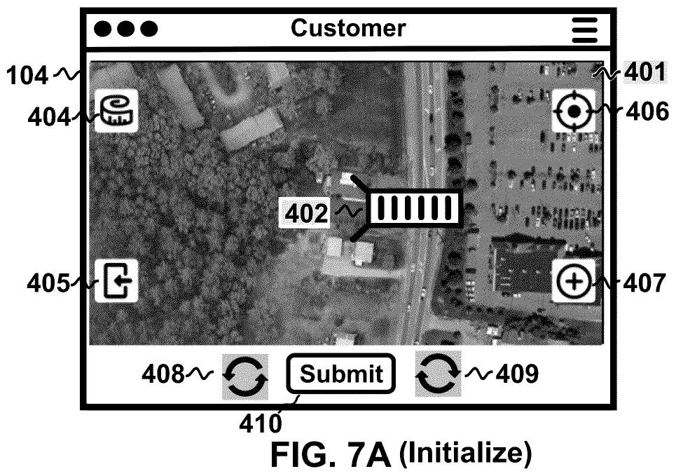

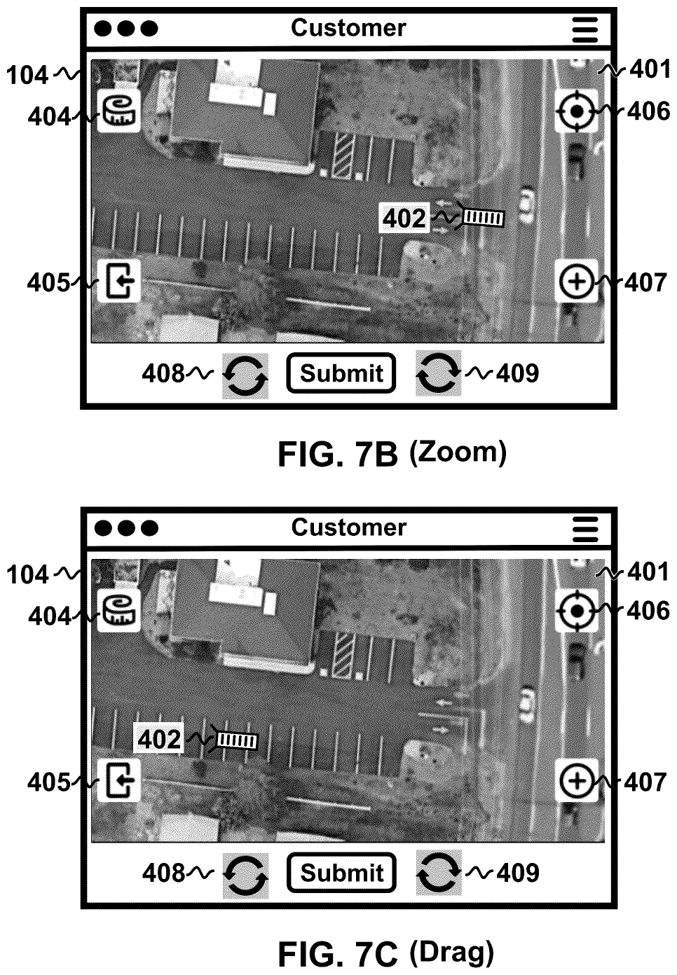

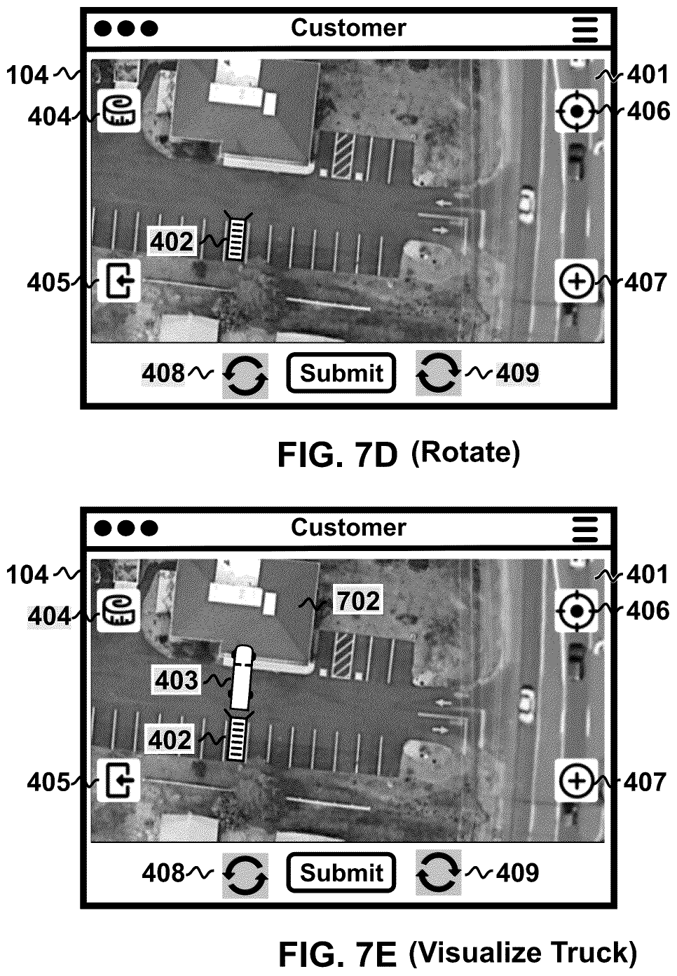

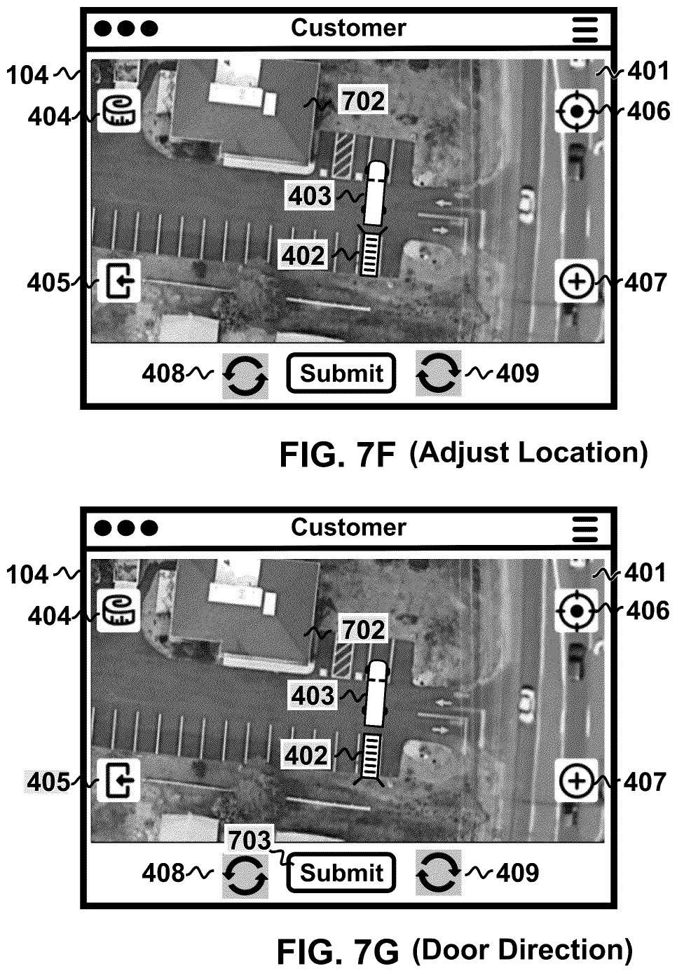

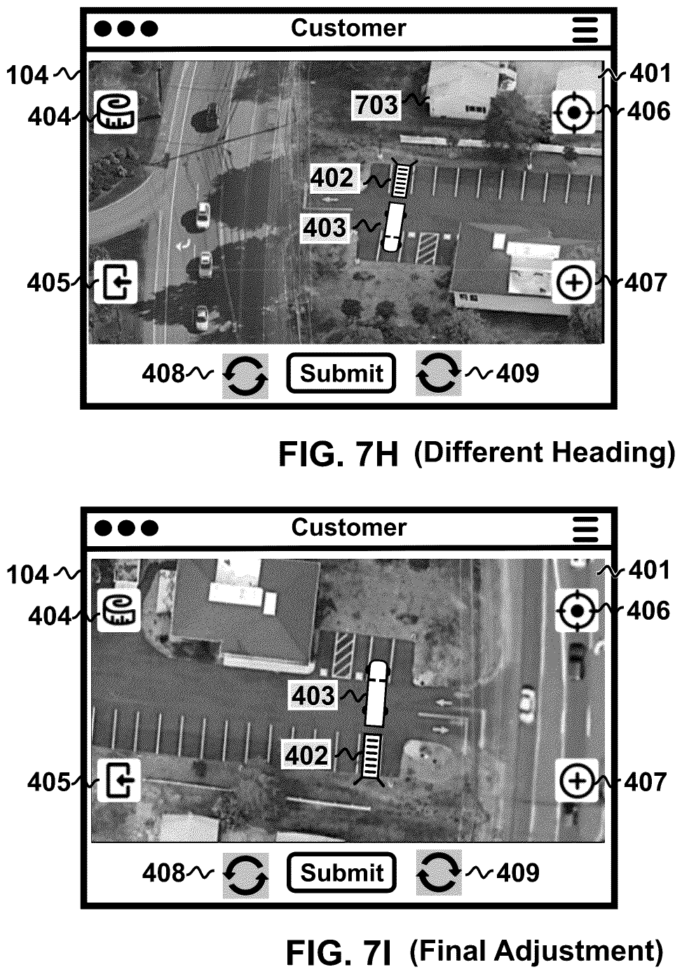

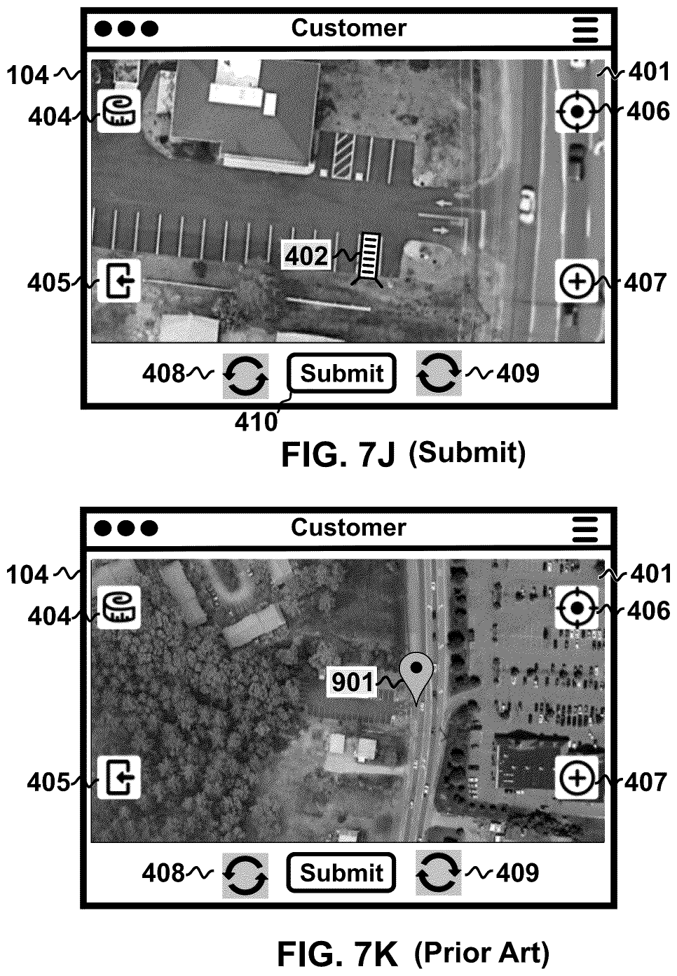

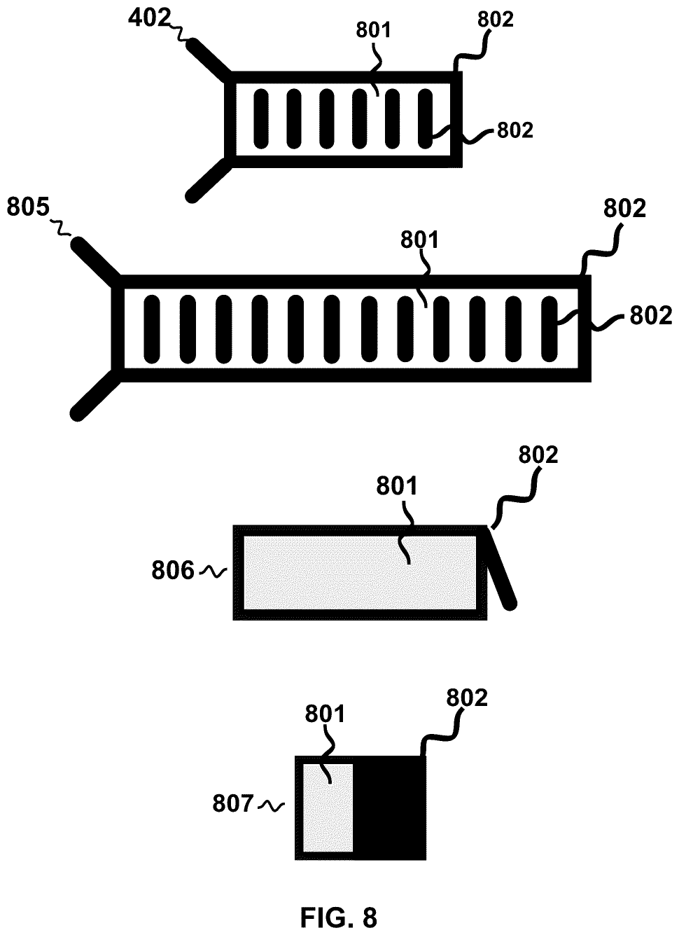

FIGS. 7a through 7j provide detailed illustrations accompanying the steps outlined in the method.

FIG. 7A demonstrates the initialization phase, where the map interface displays a deliverable asset marker (402) indicating the designated address for placement. The customer can see a general overview of the desired placement location.

FIG. 7B illustrates how the customer (105) can utilize the zoom function to enlarge the customer map module (401) and improve visibility of the surrounding area. The scaling of both the deliverable asset marker (402) and the truck-visualization marker (403) ensures accurate representation of their sizes as the map zooms in.

FIG. 7C demonstrates how the customer (105) can drag the deliverable asset marker (402) to a new location in the customer map module (401). This action allows the customer (105) to reposition the deliverable asset to the desired location.

FIG. 7D shows the customer (105) utilizing rotation controls (408) and (409) to adjust the deliverable asset marker (402) orientation. The control enables clockwise or counter-clockwise rotation in predetermined 10 degree increments.

FIG. 7E displays that when the customer activates the truck-visualization marker control by selecting (404), an additional marker representing a truck or a truck-visualization marker (403) appears on the customer map module (401). The primary purpose of the truck visualizer control (404) is to provide the customer (105) with a visual representation of truck size and the space required for delivery.

By displaying the truck-visualization marker (403), the customer (105) can evaluate potential obstacles (702) that may impede the delivery process. In this example, the customer (105) can see there is not enough room to deliver the asset to the initial placement location.

FIG. 7F shows the customer (105) can then drag the deliverable asset and truck-visualization markers (402, 403) to a new location in the customer map module (401) to ensure unobstructed delivery access. When the deliverable asset marker (402) or the truck-visualization marker (403) is moved, both move together in synchronization, as further discussed in FIG. 12.

FIG. 7G shows that the customer (105) can adjust the orientation to meet specific requirements. Where the deliverable asset doors are initially facing the truck, the customer may need them to face a building (703). This adjustment is accomplished by using the dedicated control (405) to rotate the deliverable asset marker (402) by 180 degrees.

FIG. 7H shows the customer (105) can change the map heading using control (406). When the map heading is changed, the system rotates the markers (402, 403) to match the new heading.

FIG. 7I shows that the customer (105) has the option to make final adjustments to marker positions and orientations to ensure optimal placement.

FIG. 7J outlines the concluding step, which entails clicking the submit button (410) to transmit the finalized placement data, including the positions of the deliverable asset marker (402), to the database. Upon submission, the system (100) updates the database and automatically sends a notification (106) to the dispatcher (101).

FIG. 7K illustrates an example of prior art, showcasing a basic map marker interface that lacks advanced functionality. While the marker may display the address, it does not provide precise information regarding the desired location and orientation of the deliverable asset within the property. Such markers can result in deliverable assets being placed in incorrect locations or with doors facing the wrong direction.

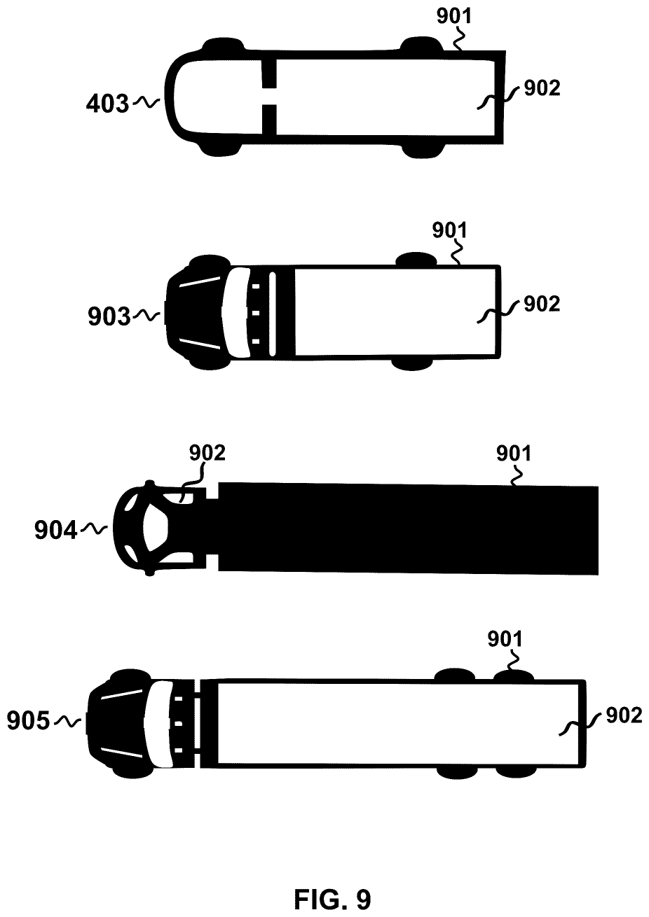

FIG. 9 shows customization of truck markers, with options for different vehicle sizes, including small trucks, extended cabs, or tractor-trailers. Colors may also be customized for clarity.

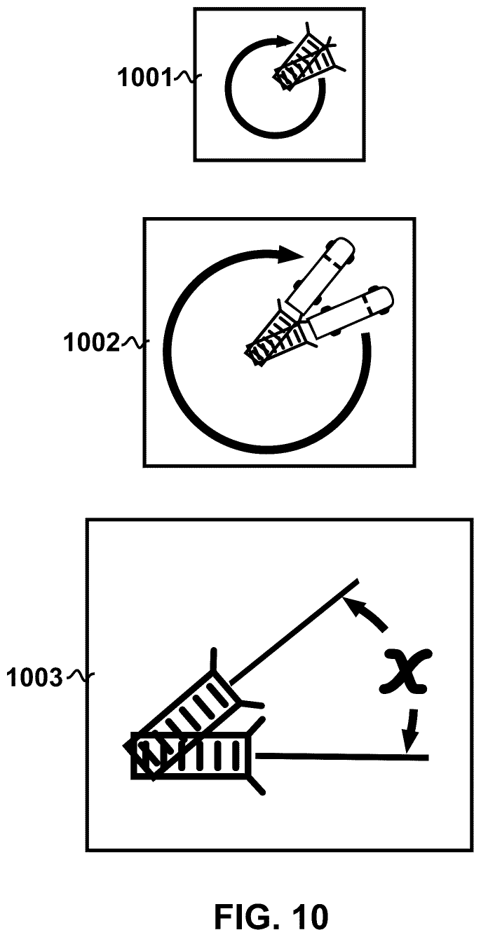

FIG. 10 shows rotation functionality, including synchronized rotation of deliverable asset and truck markers, with adjustable increment sizes.

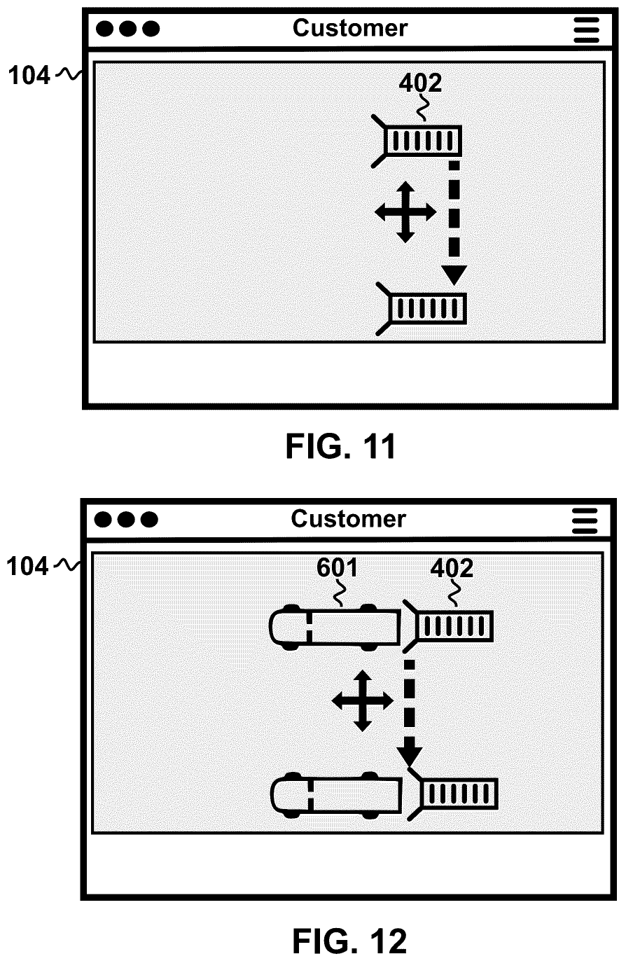

FIG. 11 shows dragging of the asset marker, with real-time updates of latitude and longitude stored in the database.

FIG. 12 shows synchronized dragging of the deliverable asset and truck markers, allowing simultaneous repositioning.

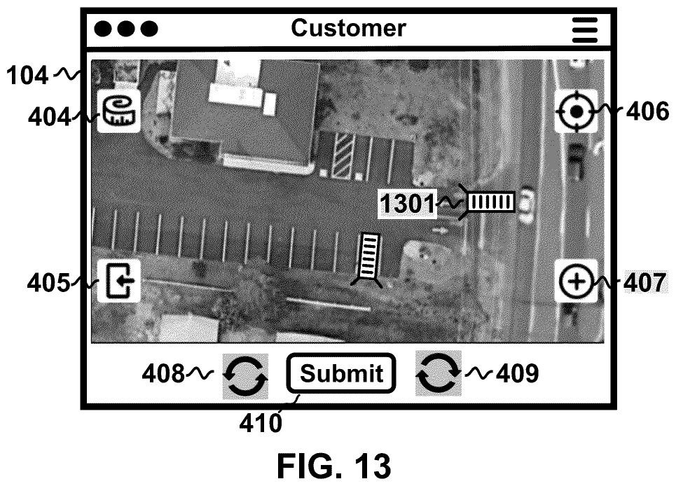

FIG. 13 shows the add control (407), enabling customers to place multiple markers (1301) to plan delivery of several assets. The system incorporates these additional placements into the database for scalability.

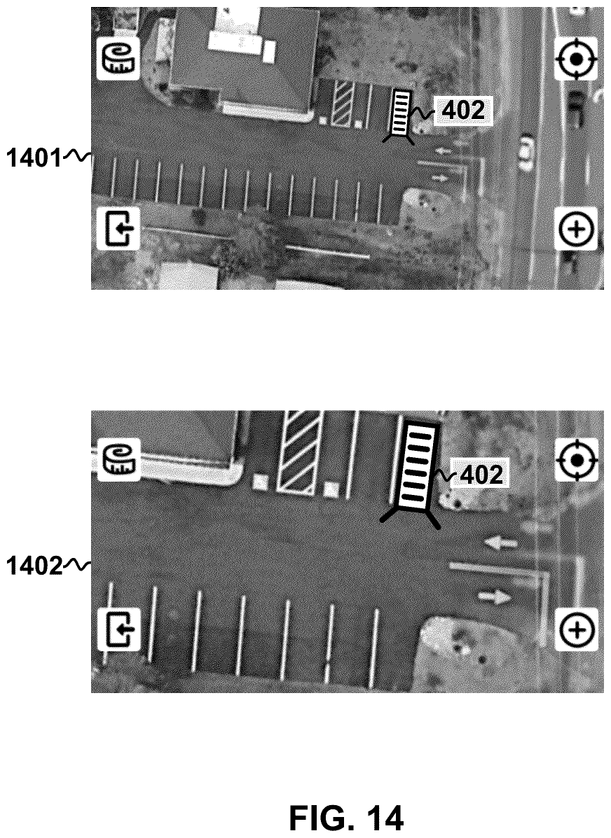

FIG. 14 shows proportional scaling of markers as the map zoom changes. Deliverable asset and truck markers maintain realistic proportions, improving visualization accuracy.

1. A computer-implemented system for facilitating the delivery and placement of a temporary, on-site deliverable asset, the system comprising: a customer interface configured to display a map module associated with a delivery address and a selected deliverable asset, the customer interface presenting: a repositionable and rotatable deliverable asset marker that visually represents the dimensions and orientation of the selected deliverable asset at the delivery address; and
a synchronously movable truck-visualization marker dynamically generated to represent a required clearance space for a delivery vehicle, wherein the size and shape of the truck-visualization marker are based on a pre-selected vehicle type; at least one control on the customer interface configured to receive a customer input for repositioning the deliverable asset marker on the map, rotating the deliverable asset marker in user-selectable increments, and toggling visibility of the truck-visualization marker; a database configured to store placement data in real time as the customer manipulates the deliverable asset marker on the map, the placement data including geocoded coordinates, orientation, and zoom level; and
a driver interface configured to access the stored placement data from the database and to display the deliverable asset marker and the truck-visualization marker at the customer-specified location and orientation.

2. The system of claim 1, further comprising a dispatcher interface configured to generate the customer-accessible map module and transmit a notification containing a hyperlink or secure portal link to the customer.

3. The system of claim 1, wherein the customer interface further comprises rotation controls enabling clockwise and counter-clockwise rotation of the deliverable asset marker in predefined increments.

4. The system of claim 1, wherein the customer interface further comprises a show/hide control to toggle visibility of the truck-visualization marker.

5. The system of claim 1, wherein the customer interface further comprises an add control enabling placement of multiple deliverable asset markers within the map module.

6. The system of claim 1, wherein the driver interface retrieves placement data by entering a placement ID associated with the customer submission.

7. The system of claim 1, further comprising functionality to adjust marker orientation synchronously with changes in map heading.

8. The system of claim 1, wherein movement of the deliverable asset marker results in synchronous movement of the truck-visualization marker, and vice versa.

9. The system of claim 1, wherein the notification comprises an email message transmitted to the customer.

10. The system of claim 1, wherein the deliverable asset comprises a storage container.

11. A computer-implemented method for facilitating the delivery and placement of a temporary, on-site deliverable asset, the method comprising: displaying, at a customer interface, a map module associated with a delivery address and a selected deliverable asset;
presenting, within the map module, a repositionable and rotatable deliverable asset marker and a synchronously movable truck-visualization marker dynamically generated to represent clearance space for a delivery vehicle, wherein the truck-visualization marker is based on a pre-selected vehicle type; receiving, at the customer interface, customer input for repositioning the deliverable asset marker, rotating the deliverable asset marker in user-selectable increments, and toggling visibility of the truck-visualization marker; storing, in a database, placement data including geocoded coordinates, orientation, and zoom level in real time as the customer manipulates the deliverable asset marker; and
rendering, at a driver interface, the deliverable asset marker and the truck-visualization marker at the customer-specified location and orientation.

12. The method of claim 11, further comprising generating, at a dispatcher interface, the customer-accessible map module and transmitting a notification containing a hyperlink or secure portal link to the customer.

13. The method of claim 11, further comprising enabling clockwise and counter-clockwise rotation of the deliverable asset marker in predefined increments.

14. The method of claim 11, further comprising toggling visibility of the truck-visualization marker.

15. The method of claim 11, further comprising enabling placement of multiple deliverable asset markers within the map module.

16. The method of claim 11, further comprising synchronously updating marker orientation with changes in map heading.

17. The method of claim 11, further comprising synchronously moving the truck-visualization marker when the deliverable asset marker is moved, and vice versa.

18. The method of claim 11, wherein the notification comprises an email message transmitted to the customer.

19. The method of claim 11, wherein the deliverable asset comprises a storage container.

20. A non-transitory computer-readable medium storing instructions that, when executed by one or more processors, cause the processors to perform operations comprising: displaying, at a customer interface, a map module associated with a delivery address and a selected deliverable asset; presenting, within the map module, a repositionable and rotatable deliverable asset marker and a synchronously movable truck-visualization marker dynamically generated to represent clearance space for a delivery vehicle, wherein the truck-visualization marker is based on a pre-selected vehicle type; receiving, at the customer interface, customer input for repositioning the deliverable asset marker, rotating the deliverable asset marker in user-selectable increments, and toggling visibility of the truck-visualization marker;
storing placement data including geocoded coordinates, orientation, and zoom level in real time as the customer manipulates the deliverable asset marker; and
rendering, at a driver interface, the deliverable asset marker and the truck-visualization marker at the customer-specified location and orientation.
